(19) United States
(12) Patent Application Publication
(10) Pub. No.: US 2025/0181366 A1
(43) Pub. Date: Jun. 5, 2025

(54) ELECTRONIC DEVICE AND METHOD FOR INITIALIZATION OPERATION

(71) Applicant: Samsung Electronics Co., Ltd., Suwon-si (KR)

(72) Inventors: Yeonho JO, Suwon-si (KR); Sangil YOON, Suwon-si (KR); Byungjai IM, Suwon-si (KR); Sangman LEE, Suwon-si (KR)

(21) Appl. No.: 19/045,927

(22) Filed: Feb. 5, 2025

Related U.S. Application Data
(63) Continuation of application No. PCT/KR2023/011588, filed on Aug. 7, 2023.

(30) Foreign Application Priority Data
Aug. 8, 2022 (KR) 10-2022-0098564
Sep. 8, 2022 (KR) 10-2022-0114055

(51) Int. Cl. G06F 9/451; G04G 9/10; G06F 3/0484; G06F 3/14

(52) U.S. Cl. CPC G06F 9/451; G04G 9/107; G06F 3/0484; G06F 3/14

(57) ABSTRACT

An electronic device is provided. The electronic device includes memory storing one or more computer programs, a display and one or more processors communicatively coupled to the memory and the display, wherein the one or more computer programs include computer-executable instructions that, when executed by the one or more processors individually or collectively, cause the electronic device to execute an application related to a system user interface (UI) in a locked state, control a display to display a first screen indicating initialization through the application, generate an image related to a watchface while performing the initialization and control the display to display the first screen and a second screen including the image, switch from the locked state to an unlocked state during the initialization, and based on completion of the initialization, control the display to remove the first screen and display the second screen.

### CROSS-REFERENCE TO RELATED APPLICATION(S)

This application is a continuation application, claiming priority under 35U.S.C. § 365 (c), of an International application No. PCT/KR2023/011588, filed on Aug. 7, 2023, which is based on and claims the benefit of a Korean patent application number 10-2022-0098564, filed on Aug. 8, 2022, in the Korean Intellectual Property Office, and of a Korean patent application number 10-2022-0114055, filed on Sep. 8, 2022, in the Korean Intellectual Property Office, the disclosure of each of which is incorporated by reference herein in its entirety.

### BACKGROUND

### 1. Field

The disclosure relates to an electronic device and method for an initialization operation.

### 2. Description of Related Art

With digital technology advancing, electronic devices come in various types, such as smartphones, tablet personal computers (PCs), or personal digital assistants (PDAs). Electronic devices have been developed to be worn by users so as to enhance portability and user accessibility.

As technology advances, wearable devices and related accessories are being developed. In particular, the market for wearable devices, including smart watches and their accessories (e.g., straps), is emerging.

The above information is presented as background information only to assist with an understanding of the disclosure. No determination has been made, and no assertion is made, as to whether any of the above might be applicable as prior art with regard to the disclosure.

### SUMMARY

For an electronic device, as a low-performance wearable device, when initialization for driving the electronic device is performed, initialization may be completed as a service or applications required in a watchface operation at the time when the watchface is shown on the display are sequentially executed. Accordingly, in the electronic device, the watchface is visible on the display as long as the time when the required service or applications are normally initialized, but may not normally operate. Thus, the time when the electronic device may actually be used may be delayed.

Aspects of the disclosure are to address at least the above-mentioned problems and/or disadvantages and to provide at least the advantages described below. Accordingly, an aspect of the disclosure is to provide an electronic device and method for an initialization operation.

Additional aspects will be set forth in part in the description which follows and, in part, will be apparent from the description, or may be learned by practice of the presented embodiments.

In accordance with an aspect of the present disclosure, an electronic device is provided. The electronic device includes memory storing one or more computer programs, a display, and one or more processors communicatively coupled to the memory and the display, wherein the one or more computer programs include computer-executable instructions that, when executed by the one or more processors individually or collectively, cause the electronic device to execute an application related to a system user interface (UI) in a locked state, control the display to display a first screen indicating initialization through the application, generate an image related to a watchface while performing the initialization and control the display to display the first screen and a second screen including the image, switch the locked state to an unlocked state while performing the initialization, and based on completion of the initialization, control the display to remove the first screen and display the second screen.

In accordance with an aspect of the present disclosure, a method performed by an electronic device is provided. The method includes executing, by the electronic device, an application related to a system user interface (UI) in a locked state, displaying, by the electronic device, a first screen indicating initialization through the application, generating, by the electronic device, an image related to a watchface while performing the initialization and displaying the first screen and a second screen including the image on a display of the electronic device, switching, by the electronic device, the locked state to an unlocked state while performing the initialization, and based on completion of the initialization, removing the first screen and display the second screen on the display.

In accordance with an aspect of the present disclosure, one or more non-transitory storage media storing one or more computer programs including computer-executable instructions that, when executed by one or more processors of an electronic device individually or collectively, cause the electronic device perform operations. The operations include executing, by the electronic device, an application related to a system user interface (UI) in a locked state, displaying, by the electronic device, a first screen indicating initialization through the application, generating, by the electronic device, an image related to a watchface while performing the initialization and displaying the first screen and a second screen including the image on a display of the electronic device, switching, by the electronic device, the locked state to an unlocked state while performing the initialization, and based on completion of the initialization, removing, by the electronic device, the first screen and display the second screen on the display.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an electronic device in a network environment according to an embodiment of the disclosure;

FIG. 2 is a view illustrating an example of a configuration of a software module in an electronic device according to an embodiment of the disclosure;

FIGS. 3A and 3B are views illustrating initialization of an electronic device according to various embodiments of the disclosure;

FIG. 4 is a graph illustrating initialization of an electronic device according to an embodiment of the disclosure;

FIG. 5 is a view illustrating an example of an operation method in an electronic device according to an embodiment of the disclosure; and

FIG. 6 is a view illustrating an example of an operation method in an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

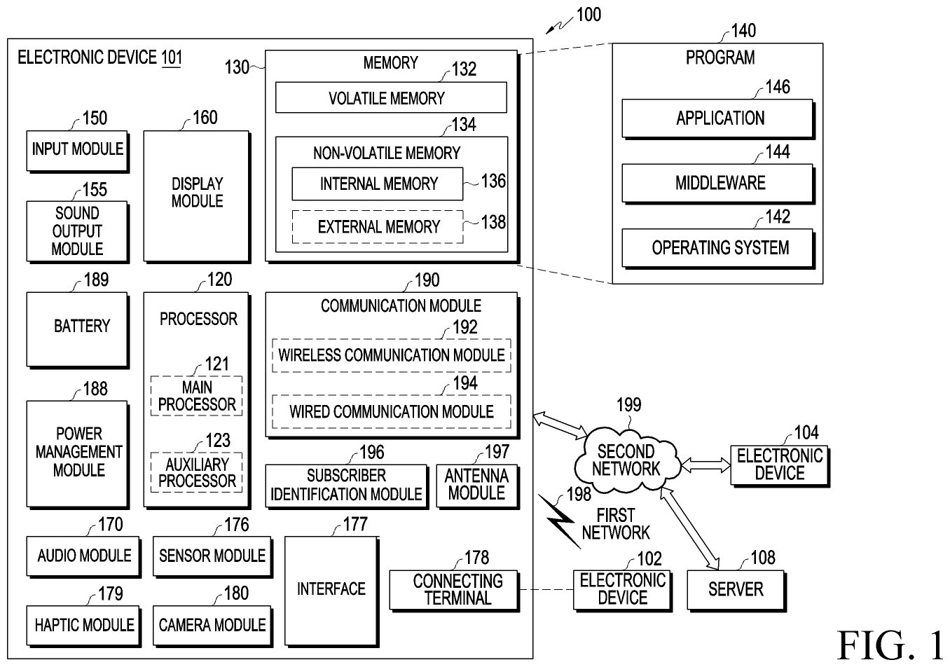

FIG. 1 is a block diagram illustrating an electronic device in a network environment according to an embodiment of the disclosure.

Referring to FIG. 1, an electronic device 101 in a network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data includes, for example, software (e.g., the program 140) and input data or output data for a command related thereto. The memory 130 may include the volatile memory 132 or the non-volatile memory 134.

The program 140 may be stored in the memory 130 as software, and includes, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 includes, for example, a microphone, a mouse, a keyboard, keys (e.g., buttons), or a digital pen (e.g., a stylus pen).

The sound output module 155 may output sound signals to the outside of the electronic device 101. The sound output module 155 includes, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 includes, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 includes, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 includes, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 includes, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 includes, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 includes, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth-generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

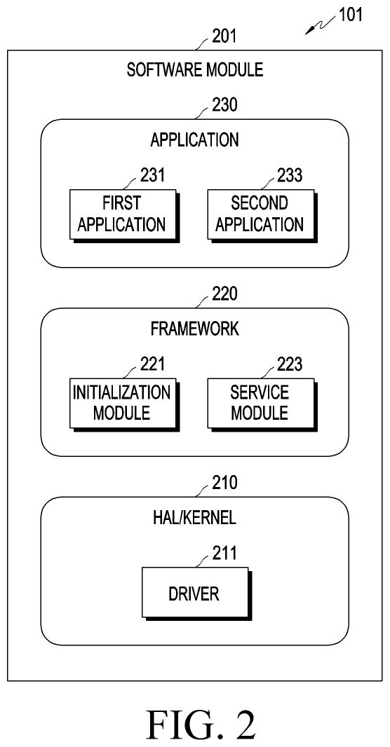

FIG. 2 is a view illustrating an example of a configuration of a software module in an electronic device according to an embodiment of the disclosure.

Referring to FIGS. 1 and 2, an electronic device according to an embodiment may implement a software module 201 (e.g., the program 140 of FIG. 1) for executing operations for enhancing the booting speed of the electronic device. The memory 130 of the electronic device 101 may store commands (e.g., instructions) for implementing the software module 201 of FIG. 2. The at least one processor 120 may execute instructions stored in the memory 130 to implement the software module 201 illustrated in FIG. 2, and may control hardware (e.g., the display module 160, sensor module 176, power management module 188, or communication module 190 of FIG. 1) associated with the function of the software module 201.

Referring to FIG. 2, the software module 201 of the electronic device 101 according to an embodiment may include a kernel 210 (or a HAL), a framework 220 (e.g., the middleware 144 of FIG. 1), and an application 230 (e.g., the application 146 of FIG. 1). At least a portion of the software module 201 may be preloaded on the electronic device 101 or may be downloaded from a server (e.g., the server 108).

According to an embodiment, the kernel 210 may include, e.g., a system resource manager or a device driver 211, but is not limited thereto and may be configured to further include other modules. The system resource manager may perform at least one of control, allocation, or recovery of system resources. The device driver 211 may include, e.g., a display driver, a camera driver, a Bluetooth driver, a shared memory driver, a USB driver, a keypad driver, a Wi-Fi driver, an audio driver, or an inter-process communication (IPC) driver.

According to an embodiment, the framework 220 may be configured to include, e.g., an initialization module 221 and a service module 223 but, without limitations thereto, may be configured to include other modules. The framework 220 may provide functions commonly required by the application 230, or may provide various functions to the application 230 through an application programming interface (API) (not shown) such that the application 230 may efficiently use limited system resources inside the electronic device 101. The initialization module 221 may perform initialization (e.g., booting) for executing the operating system in response to an initialization request of the electronic device 101 and execute initialization of modules required to drive the electronic device 101, included in the application 230. The framework 220 may include a module that forms a combination of various functions of the above-described components. The initialization module 221 may start initialization in a locked state of the electronic device 101 and, while performing initialization, the electronic device 101 may switched to an unlocked state. Here, the locked state may mean a state in which access permission to the credential encryption storage is not obtained, and the unlocked state may mean a state in which access permission to the credential encryption storage is obtained. The credential encryption storage is the default storage of the electronic device 101 and may store data that should be encrypted with a key associated with user authentication information, such as the personal identification number (PIN) or password. The initialization module 221 may process a request for changing the frames per second (fps) of the watchface and then process of the application and transfer a request for displaying the watchface to the second application 233. The service module 223 may perform an operation for processing the processes of the module or application executed after the initialization is completed. The framework 220 may provide a specified module per type of the operating system in order to provide a differentiated function. The framework 220 may dynamically omit some existing components or add new components. The framework 220 may further include a module (or service) (not shown) for wireless communication with an external electronic device (e.g., the electronic device 102 or 104 of FIG. 1 or the server 108).

According to an embodiment, the application 230 may be configured to include an initialization-related application (e.g., a module, a manager, or a program) to enhance the booting speed. For example, a first application (sysui application) 231 related to a system user interface and a second application 233 related to a watchface may be included. The first application 231 may set or variably change the number of frames per second of the initialization-related process and watchface until the initialization is completed, and process a process related to display and deletion of the first screen indicating the initialization. The application 230 may include an application received from an external electronic device (e.g., the server 108 or the electronic devices 102 and 104). According to an embodiment, the application 230 may include a preloaded application or a third party application downloadable from a server. According to the illustrated embodiment, the components of the software module 201 and the names of the components may be varied depending on the type of the operating system. According to an embodiment, at least a part of the software module 201 may be implemented in software, firmware, hardware, or in a combination of two or more thereof. At least part of the software module 201 may be implemented (e.g., executed) by e.g., a processor (e.g., an AP). At least a part of the software module 201 may include at least one of, e.g., a module, program, routine, set of instructions, process, or the like for performing at least function.

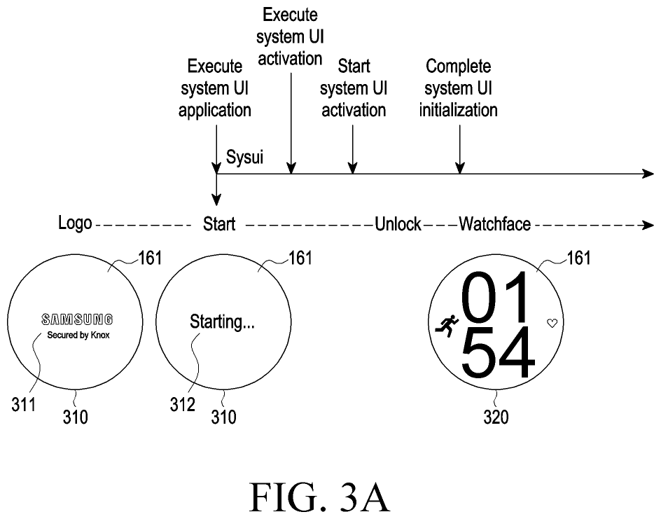

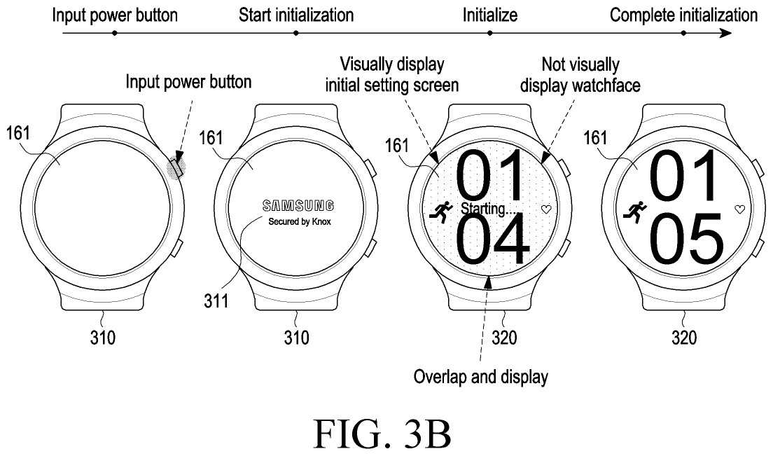

FIGS. 3A and 3B are views illustrating initialization of an electronic device according to various embodiments of the disclosure.

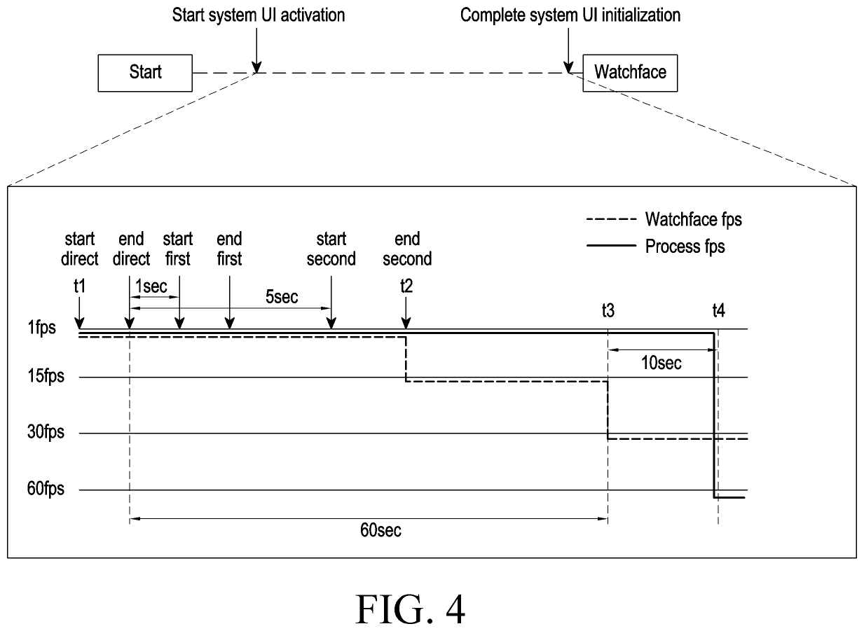

FIG. 4 is a graph illustrating initialization of an electronic device according to an embodiment of the disclosure.

Referring to FIGS. 1, 2, 3A, 3B, and 4, the electronic device 101 (e.g., the electronic device 101 of FIG. 1) according to an embodiment may be a wearable device (e.g., a watch-type wearable device). The electronic device 101 may include a processor 120, memory 130, and a display module 160 including a display 161. Further, the electronic device 101 may further include other components (e.g., other components shown in FIG. 1) necessary to enhance the booting speed.

According to an embodiment, the processor 120 (e.g., the processor 120 of FIG. 1) of the electronic device 101 may be electrically connected to the memory 130 and the display module 160, and may control the software module 201 to perform an initialization (e.g., booting) operation for starting the operating system (e.g., the operating system 142 of FIG. 1 or the software module 201 of FIG. 2) of the electronic device 101. The processor 120 may perform the initialization operation to enhance the booting performance of the electronic device 101 and, when switching to the unlocked state so that the screen (e.g., the second screen) related to the watchface is displayed to be shown to the user, allow the module related to the system UI and the module related to the watchface to be immediately used. Here, the watchface is an execution screen (e.g., background screen) that is first displayed on the display when initialization is completed after switching to the unlocked state of the electronic device 101, and may be a screen that displays a user interface (e.g., image or graphic element) set based on information related to the execution of at least one application (e.g., function, service, or program). Hereinafter, for convenience of description, the execution screen displayed in relation to the watchface through the initialization operation according to an embodiment will be referred to as a second screen.

According to an embodiment, the processor 120 may start an initialization operation in the locked state and execute (create sysui application) an application related to the system user interface (UI) in the locked state, e.g., in response to an input of a power button. According to an embodiment, the processor 120 may perform activation execution (create sysui activity) of the system user interface through the application related to the system user interface (UI) and perform the start of activation of the system user interface (initialize sysui activity). The processor 120 may control the display 161 to display the first screen 310 indicating initialization at the time of executing the application. According to an embodiment, the processor 120 may control the display 161 to display an initialization screen 310 including images (e.g., visual effects or graphic elements) 311 and 312 related to the initialization operation in the locked state. Here, the initialization screen 310 may refer to a screen displayed on the display 161 when initialization (e.g., booting) is started. For example, the initialization screen 310 includes an image 311 including information (e.g., logo) related to the manufacturer of the electronic device 101 and an image (e.g., “starting”) 312 for indicating the initialization.

According to an embodiment, referring to FIG. 3A, the processor 120 may generate an image related to the watchface while performing initialization and to control the display 161 to display a second screen 320 including the image generated using the display 161 simultaneously with the first screen 310. For example, the processor 120 displays the second screen 320 to be covered by being overlapped by the first screen 310. While the second screen 320 and the first screen 310 are displayed, the second screen 320 may not be visible to the user.

According to an embodiment, referring to FIG. 3B, the processor 120 may start the initialization operation in the locked state in response to a power button input (press power button), execute the application related to the system user interface (UI) in the locked state, and control the display 161 to display the first screen 310 indicating the start of initialization (start initialization) and the initialization being performed (initialization) at the time of execution of the application. The processor 120 may control the display 161 to display an initialization screen 310 including images 311 and 312 related to the initialization (e.g., visual effects or graphic elements) while performing initialization in the locked state. The processor 120 may set the transparency of the second screen 320 to 100% while the second screen 320 is displayed by being covered to overlap the first screen 310 (initialization) and, if the initialization is completed (finish initialization) after the second screen 320 is displayed overlapping the first screen 310, change the transparency of the second screen 320 to 0%, and control the display 161 to remove the first screen 310 so that only the second screen 320 is displayed. According to an embodiment, the processor 120 may control the display 161 to gradually decrease the transparency value while displaying the second screen 320 in the background as the fps value of the second screen 320 is sequentially changed with the transparency of the second screen 320 falling within a range of 0 to 100% and, if the initialization is completed (finish initialization), remove the first screen 310 so that only the second screen 320 is displayed.

According to an embodiment, the processor 120 may switch the locked state to the unlocked state while performing the initialization and, based on completion of the initialization (finish sysui initialization), control the display 161 to remove the first screen 310 and display the second screen 320 to be shown to the user. Here, the watchface may be executed in the background while performing initialization in the locked state. For example, the watchface means a screen that is processed by one or more modules (e.g., application, function, or program) providing information through the watchface to be shown to the user immediately after the initialization is completed, and previously executed while initialization is performed. According to an embodiment, the watchface may be, e.g., a health- or watch-related application. According to an embodiment, the application may be an application that collectively provides various functions in conjunction with a health-and/or watch-related application. Without limitations thereto, as the application executed while initialization is performed, various applications may be applied according to the user's setting and system implementation.

According to an embodiment, the processor 120 may display the first screen 310 and the second screen 320 to overlap each other when displaying the second screen 320 to be not shown to the user by being covered by the first screen 310 which is the initialization screen or to be visible by gradually adjusting the transparency of the second screen 320. Here, the second screen 320 may be displayed and updated as the background screen while being displayed overlapping the first screen 310. For example, the processor controls the display 161 to display the first screen 310 on the uppermost layout and the second screen 320 on the lower layout. For example, the processor 120 controls the display 161 so that the second screen 320 is rendered to be transparent so as not to be shown to the user.

According to an embodiment, the processor 120 may set each of the number of frames per second of the application and the number of frames per second of the watchface during a first time period t1-t2 while performing the initialization and control the display 161 to display the first screen 310 and the second screen 320 each at the number of frames per second of the first value. Here, the number of frames per second may mean the frequency at which the display is displayed. Here, the first time period (e.g., the t1-t2 time period of FIG. 4) may be a time period during which initialization of modules (e.g., at least one of a watchface engine module, watchface picker module, notification module, tile module, or tutorial module) required to configure the second screen 320 related to the watchface.

According to an embodiment, if the initialization operation of the modules necessary to configure the second screen 320 related to the watchface is completed, as shown in FIG. 4, the processor 120 may change the first value (e.g., 1 fps) to a second value (e.g., 15 fps) and control the display 161 to display the second screen 320 related to the watchface at the number of frames per second of the changed second value. The processor 120 may set the number of frames per second of the watchface to maintain the second value during the second time period t2-t3 from the second time t2 to the third time t3. Here, the second time period (e.g., the t2-t3 time period of FIG. 4) may be a time period during which initialization of modules (e.g., at least one of a noti module or batterystate module) required to configure the second screen 320 related to the watchface. According to an embodiment, if the initialization operation of the other modules than the modules necessary to configure the second screen 320 related to the watchface is completed at the third time t3, the processor 120 may change the second value to a third value (e.g., 30 fps) at the third time t3 and control the display 161 to display the second screen 320 related to the watchface at the number of frames per second of the changed third value. The processor 120 may set the number of frames per second of the watchface to maintain the third value from the third time t3 to the fourth time t4. Without limitations thereto, according to an embodiment, if the initialization operation of the other modules than the modules necessary to configure the second screen 320 related to the watchface is completed at the third time t3, the processor 120 may maintain the first value (e.g., 1 fps) from the first time t1 to the second time t2, change the first value to the third value (e.g., 30 fps) at the third time t3, and control the display 161 to display the second screen 320 related to the watchface at the number of frames per second of the changed third value. The processor 120 may set the number of frames per second of the watchface to maintain the third value from the third time t3 to the fourth time t4.

According to an embodiment, the processor 120 may maintain the first value (e.g., 1 fps) from the first time t2 to the fourth time t4 and then, at the fourth time t4, change the number of frames per second of the process according to execution of the application from the first value (e.g., 1 fps) to a fourth value (e.g., 60 fps).

According to an embodiment, if the initialization operation is completed at the fourth time t4, the processor 120 may remove the first screen 310 so that the second screen 320 related to the watchface, which is not shown by being covered by the first screen 310, is shown to the user immediately at the fourth time t4.

As such, in an embodiment, the main components of the electronic device have been described through the electronic device 101 of FIGS. 1 and 2. According to an embodiment, however, all of the components of FIGS. 1 and 2 are not essential components, and the electronic device 101 may be implemented with more or less components than those shown. The positions of the major components of the electronic device 101 described above in connection with FIGS. 1 and 2 may be varied according to various embodiments of the disclosure.

According to an embodiment, an electronic device (e.g., the electronic device 101 of FIGS. 1 and 2) may comprise memory (e.g., the memory 130 of FIG. 1), a display (e.g., the display included in the display module 160 of FIG. 1 or the display 161 of FIGS. 3A and 3B), and at least one processor (e.g., the processor 120 of FIG. 1) electrically connected to the memory and the display.

According to an embodiment, the instructions may, when executed by the at least one processor individually or collectively, cause the electronic device to execute an application (e.g., the first application 231 of FIG. 2) related to a system user interface (UI) in a locked state.

According to an embodiment, the instructions may, when executed by the at least one processor individually or collectively, cause the electronic device to control the display to display a first screen (e.g., the first screen 310 of FIGS. 3A and 3B) indicating initialization through the application.

According to an embodiment, the instructions may, when executed by the at least one processor individually or collectively, cause the electronic device to generate an image related to a watchface while performing the initialization and control the display to display the first screen and a second screen (e.g., the second screen 320 of FIGS. 3A and 3B) including the image.

According to an embodiment, the instructions may, when executed by the at least one processor individually or collectively, cause the electronic device to switch the locked state to an unlocked state while performing the initialization.

According to an embodiment, the instructions may, when executed by the at least one processor individually or collectively, cause the electronic device to, based on completion of the initialization, control the display to remove the first screen and display the second screen.

According to an embodiment, the instructions may, when executed by the at least one processor individually or collectively, cause the electronic device to set each of a number of frames per second of the application and a number of frames per second of the watchface to a first value after starting the initialization. According to an embodiment, the instructions may, when executed by the at least one processor individually or collectively, cause the electronic device to control the display to display each of the first screen and the second screen at the number of frames per second of the first value during a first time period after starting the initialization.

According to an embodiment, the instructions may, when executed by the at least one processor individually or collectively, cause the electronic device to change the number of frames per second of the watchface from the first value to a second value based on the switch to the unlocked state and completion of initial execution of at least one module related to the watchface. According to an embodiment, the instructions may, when executed by the at least one processor individually or collectively, cause the electronic device to control the display to display the second screen at the number of frames per second of the second value and the first screen at the number of frames per second of the first value during a second time period after the completion of the initial execution of the at least one module related to the watchface.

According to an embodiment, the instructions may, when executed by the at least one processor individually or collectively, cause the electronic device to change the number of frames per second of the watchface to a third value after a specified time (10 seconds) elapses after the change to the second value, and before completion of the initialization.

According to an embodiment, the instructions may, when executed by the at least one processor individually or collectively, cause the electronic device to control the display to display the second screen at the number of frames per second of the third value from the time of the change to the third value. According to an embodiment, the first value may be a value less than the second value, and the third value may be a value greater than the second value.

According to an embodiment, the instructions may, when executed by the at least one processor individually or collectively, cause the electronic device to change the number of frames per second of the application related to the system user interface from the first value to a fourth value after a specified time elapses from the time of changing the number of frames per second of the watchface to the third value and before the first screen is removed.

According to an embodiment, the image included in the second screen may include objects indicating information related to execution of modules related to the watchface.

According to an embodiment, the instructions may, when executed by the at least one processor individually or collectively, cause the electronic device to control a first application module included in a software module stored in the memory to process a process for displaying the first screen, performing the initialization, and executing the application.

According to an embodiment, the instructions may, when executed by the at least one processor individually or collectively, cause the electronic device to control a second application module included in the software module to process a process for displaying the second screen. According to an embodiment, the second application module may process a process related to execution of the watchface and include at least one module related to the watchface.

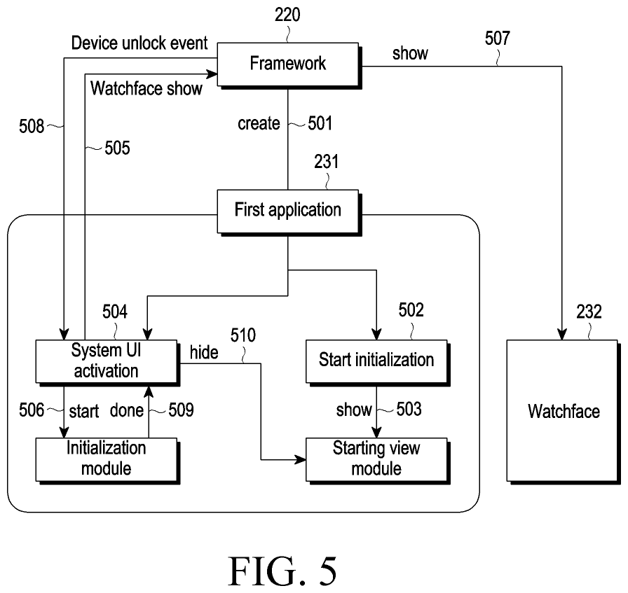

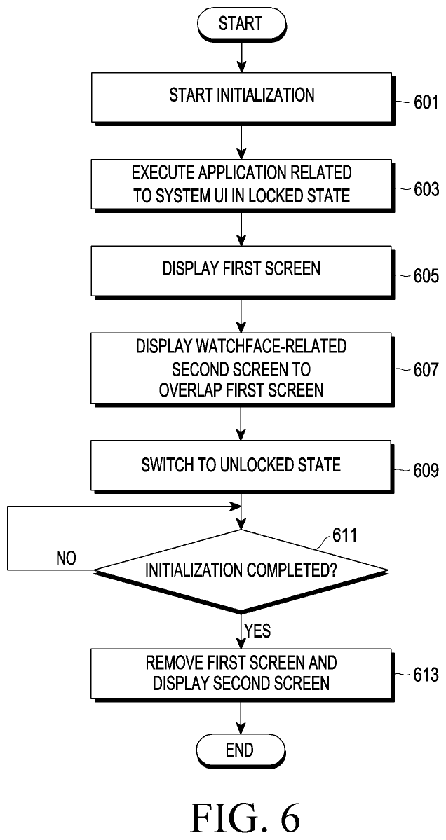

FIGS. 5 and 6 are views illustrating a method for operation in an electronic device according to various embodiments of the disclosure.

Referring to FIGS. 5 and 6, the electronic device (e.g., the electronic device 101 of FIGS. 1 and 2) according to an embodiment may start initialization (e.g., booting) in the locked state in operation 601. In response to an input of a power button, the electronic device may transfer (501) an application execution request (create) to the first application (sysui application) 231 from the framework 220 of the software module 201.

In operation 603, the electronic device may execute an application (e.g., the first application 231 of FIG. 2) related to the system user interface (UI) in the locked state. The first application 231 of the electronic device may start (502) (starting initializer) initialization in the locked state. According to an embodiment, the electronic device may change each of the number of frames per second of the application and the number of frames per second of the watchface to a lower value and then change it to a higher value while performing initialization. After starting the initialization, the electronic device may set or change each of the number of frames per second of the application and the number of frames per second of the watchface to a lower first value (e.g., 1 fps).

In operation 605, the electronic device may display, on the display (e.g., the display module 160 of FIG. 1 and the display 161 of FIG. 2), a first screen (e.g., the first screen 310 of FIGS. 3A and 3B) which is the initialization screen indicating the initialization through the executed application. The first application 231 of the electronic device may display (503) the first screen indicating the initialization through an internal module (e.g., a starting view module).

In operation 607, while performing the initialization, the electronic device may generate an image related to the watchface and display, on the display, the first screen and the second screen including the image. The electronic device may display, on the display, the second screen (e.g., the second screen 320 of FIGS. 3A and 3B) including the image related to the watchface to be covered or overlapped by, e.g., the first screen. According to an embodiment, the first application 231 of the electronic device may activate (504) the system user interface (sysui) through an internal module (e.g., a system UI activation (sysui activity) module), and the first application 231 may request (505) the framework 220 to display the watchface. The framework 220 may request (507) the second application 233 of the watchface to display the second screen related to the watchface in response to a watchface display request. The first application 231 may perform (506) initialization on the modules related to the watchface necessary to configure the second screen through an internal module (e.g., an initializer module). According to an embodiment, the electronic device may display, on the display, the second screen to overlap the first screen not to be visible by being covered by the first screen. According to an embodiment, the electronic device may set the transparency of the second screen 320 to 100% while the second screen 320 is displayed by being covered to overlap the first screen 310 and, if the initialization is completed, change the transparency of the second screen 320 to 0%, and remove the first screen 310 so that only the second screen 320 is displayed. Here, the second screen may be displayed and updated as the background screen not to be visible to the user by being covered by the first screen or to be gradually viewed by adjusting the transparency. For example, the electronic device displays the first screen on the uppermost layout and the second screen on the lower layout. For example, the electronic device processes the second screen to be transparent and display it not to be shown to the user. According to an embodiment, the electronic device may display, on the display, each of the first screen and the second screen at the number of frames per second of the first value during the first time period (e.g., the t1-t2 time period of FIG. 4) after starting the initialization. Here, the first time period (e.g., the t1-t2 time period of FIG. 4) may be a time period during which initialization of modules (e.g., at least one of a watchface engine module, watchface picker module, notification module, tile module, or tutorial module) required to configure the second screen related to the watchface. According to an embodiment, the electronic device may change the number of frames per second of the watchface from the first value (e.g., 1 fps) to the second value (e.g., 15 fps) if the initialization of the modules related to the watchface is completed in the first time period. By displaying the second screen at the number of frames per second changed to the second value, the electronic device may provide as natural an operation as possible when an animation effect occurs while the initialization is performed. According to an embodiment, if the initialization of the modules (e.g., noti module and/or batterystate module) not required in configuring the second screen is completed, the electronic device may change or recover the number of frames per second of the watchface from the second value to the third value (e.g., 30 fps) and display the second screen related to the watchface at the third value, thereby naturally displaying the second screen immediately when the second screen is shown to the user. Here, the time of completion of the initialization execution of the modules not required in configuring the second screen may be a time t3, which is a predetermined time (e.g., the t2-t3 time period of FIG. 4) after it is changed (t2) to the second value before the initialization is completed. According to an embodiment, the electronic device may change the number of frames per second of the application (or process according to the execution of the application) from the first value to the fourth value before (e.g., the time t4 of FIG. 4) removing the first screen and after a specified time (e.g., 10 seconds) elapses from the time (e.g., the time t3 of FIG. 4) when the number of frames per second of the watchface is changed to the third value. The electronic device may maintain the number of frames per second of the process according to the execution of the application as the first value (e.g., 1 fps) from the time t1 to the time t4 of FIG. 4.

In operation 609, the electronic device may switch the locked state to the unlocked state while performing the initialization. According to an embodiment, the first application 231 of the electronic device may receive a request (or command) 508 for switching the electronic device to the unlocked state from the framework 220 and switch the locked state to the unlocked state through an internal function (or module) (e.g., system UI activation (sysui activity)). For example, the electronic device switches to the unlocked state when starting, or while performing, the initialization of the modules necessary to configure the second screen related to the watchface.

In operation 611, the electronic device may identify whether the initialization is completed. As a result of the identification, if the initialization is completed, the electronic device may perform operation 613 and, if the initialization is not completed, perform operation 611 again.

In operation 613, the electronic device may remove the first screen and display the second screen on the display in response to the completion of the initialization. According to an embodiment, if the initialization is completed (509), the first application 231 of the electronic device may request (510) another module (e.g., starting view module) to hide the first screen through an internal function (or module) (e.g., system UI activation (sysui activity)).

According to an embodiment, the electronic device may execute the generation and initialization operation of the application (e.g., home application) related to the system user interface in the locked state of the electronic device, initialize the module related to the watchface before the initialization is completed, and display the second screen related to the watchface while overlapping the first screen of the application. Accordingly, when the initialization operation is completed, the electronic device may remove the first screen so that the second screen is immediately shown to the user and allow the watchface to be immediately used, thereby enhancing booting speed and removing the dark screen that is generated by an unnecessary operation.

Further, according to an embodiment, the electronic device may set the number of frames per second of the process of the system user interface application and the watchface to a lower value until the initialization is completed and change it to a higher value sequentially or at once, thereby preventing unnecessary CPU usage due to a display update in the period when the actual screen does not operate. According to an embodiment, it is possible to stop the user's entry by quickly generating a different screen using a method (direct boot method) for enhancing the booting speed in an electronic device which is a low-spec wearable device and prevent a lowering of the booting speed and unsmooth execution after booting. Other various effects may be provided directly or indirectly in the disclosure.

According to an embodiment, a method for operation in an electronic device (e.g., the electronic device 101 of FIGS. 1 and 2) may comprise executing an application related to a system user interface (UI) in a locked state.

According to an embodiment, the method may comprise displaying a first screen (e.g., the first screen 310 of FIGS. 3A and 3B) indicating initialization through the application.

According to an embodiment, the method may comprise generating an image related to a watchface while performing the initialization and displaying the first screen and a second screen (e.g., the second screen 320 of FIGS. 3A and 3B) including the image on a display (e.g., the display module 160 of FIG. 1 and the display 161 of FIG. 2) of the electronic device.

According to an embodiment, the method may comprise switching the locked state to an unlocked state while performing the initialization.

According to an embodiment, the method may comprise, based on completion of the initialization, removing the first screen and display the second screen on the display.

According to an embodiment, the method may further comprise changing each of a number of frames per second of the application and a number of frames per second of the watchface while performing the initialization.

According to an embodiment, changing each of the number of frames per second of the application and the number of frames per second of the watchface while performing the initialization may include setting each of a number of frames per second of the application and a number of frames per second of the watchface to a first value after starting the initialization, and displaying, on the display, each of the first screen and the second screen at the number of frames per second of the first value during a first time period after starting the initialization.

According to an embodiment, changing each of the number of frames per second of the application and the number of frames per second of the watchface while performing the initialization may further include changing the number of frames per second of the watchface from the first value to a second value based on the switch to the unlocked state and completion of initial execution of at least one module related to the watchface, and displaying the second screen at the number of frames per second of the second value and the first screen at the number of frames per second of the first value during a second time period after the completion of the initial execution of the at least one module related to the watchface.

According to an embodiment, changing each of the number of frames per second of the application and the number of frames per second of the watchface while performing the initialization may further include changing the number of frames per second of the watchface to a third value after a specified time (10 seconds) elapses after the change to the second value, and before completion of the initialization, and displaying the second screen at the number of frames per second of the third value from the time of the change to the third value.

According to an embodiment, the first value may be a value less than the second value, and the third value may be a value greater than the second value.

According to an embodiment, changing each of the number of frames per second of the application and the number of frames per second of the watchface while performing the initialization may further include changing the number of frames per second of the application from the first value to a fourth value after a specified time elapses from the time of changing the number of frames per second of the watchface to the third value and before the first screen is removed.

According to an embodiment, the image included in the second screen may include objects indicating information related to execution of modules related to the watchface.

According to an embodiment, in a non-transitory storage medium storing a program, the program may include instructions that, when executed by at least one processor (e.g., the processor 120 of FIG. 1) of an electronic device (e.g., the electronic device 101 of FIGS. 1 and 2) individually or collectively, cause the electronic device to execute an application (e.g., the first application 231 of FIG. 2) related to a system user interface (UI) in a locked state, display a first screen (e.g., the first screen 310 of FIGS. 3A and 3B) indicating initialization through the application, generate an image related to a watchface while performing the initialization and displaying the first screen and a second screen (e.g., the second screen 320 of FIGS. 3A and 3B) including the image on a display (e.g., the display module 160 of FIG. 1 and the display 161 of FIG. 2) of the electronic device, switch the locked state to an unlocked state while performing the initialization, and based on completion of the initialization, remove the first screen and display the second screen on the display.

According to an embodiment, the non-transitory storage medium storing the program may comprise instructions that causes the electronic device to further execute changing each of a number of frames per second of the application and a number of frames per second of the watchface while performing the initialization.

According to an embodiment, changing each of the number of frames per second of the application and the number of frames per second of the watchface while performing the initialization may include an executable instruction to execute setting each of a number of frames per second of the application and a number of frames per second of the watchface to a first value after starting the initialization, and displaying, on the display, each of the first screen and the second screen at the number of frames per second of the first value during a first time period after starting the initialization.

According to an embodiment, changing each of the number of frames per second of the application and the number of frames per second of the watchface while performing the initialization may include an executable instruction to execute changing the number of frames per second of the watchface from the first value to a second value based on the switch to the unlocked state and completion of initial execution of at least one module related to the watchface, and displaying the second screen at the number of frames per second of the second value and the first screen at the number of frames per second of the first value during a second time period after the completion of the initial execution of the at least one module related to the watchface.

According to an embodiment, changing each of the number of frames per second of the application and the number of frames per second of the watchface while performing the initialization may include an executable instruction to execute changing the number of frames per second of the watchface to a third value after a specified time (10 seconds) elapses after the change to the second value, and before completion of the initialization, displaying the second screen at the number of frames per second of the third value from the time of the change to the third value, and changing the number of frames per second of the application from the first value to a fourth value before a specified time elapses from the time of changing the number of frames per second of the watchface to the third value and before the first screen is removed. According to an embodiment, the first value may be a value less than the second value, and the third value may be a value greater than the second value.

The embodiments disclosed herein are proposed for description and understanding of the disclosed technology and does not limit the scope of the disclosure. Accordingly, the scope of the disclosure should be interpreted as including all changes or various embodiments based on the technical spirit of the disclosure.

The electronic device according to various embodiments of the disclosure may be one of various types of electronic devices. The electronic devices includes, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module is implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) invokes at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
memory storing one or more computer programs;
a display; and
one or more processors communicatively coupled to the memory and the display, wherein the one or more computer programs include computer-executable instructions that, when executed by the one or more processors individually or collectively, cause the electronic device to:
execute an application related to a system user interface (UI) in a locked state,
control the display to display a first screen indicating initialization through the application,
generate an image related to a watchface while performing the initialization and control the display to display the first screen and a second screen including the image,
switch the locked state to an unlocked state while performing the initialization, and
based on completion of the initialization, control the display to remove the first screen and display the second screen.

2. The electronic device of claim 1,
wherein the one or more computer programs further include computer-executable instructions that, when executed by the one or more processors individually or collectively, cause the electronic device to:
set each of a number of frames per second of the application and a number of frames per second of the watchface to a first value after starting the initialization, and
control the display to display each of the first screen and the second screen at the number of frames per second of the first value during a first time period after starting the initialization, and
wherein the image included in the second screen includes objects indicating information related to execution of modules related to the watchface.

3. The electronic device of claim 2, wherein the one or more computer programs further include computer-executable instructions that, when executed by the one or more processors individually or collectively, cause the electronic device to:
based on the switching to the unlocked state and completion of initial execution of at least one module related to the watchface, change the number of frames per second of the watchface from the first value to a second value, and
control the display to display the second screen at the number of frames per second of the second value and the first screen at the number of frames per second of the first value during a second time period after the completion of the initial execution of the at least one module related to the watchface.

4. The electronic device of claim 3,
wherein the one or more computer programs further include computer-executable instructions that, when executed by the one or more processors individually or collectively, cause the electronic device to:
change the number of frames per second of the watchface to a third value after a specified time elapses after the change to the second value, and before completion of the initialization, and
control the display to display the second screen at the number of frames per second of the third value from a time of the change to the third value, wherein the first value is a value less than the second value, and wherein the third value is a value greater than the second value.

5. The electronic device of claim 4, wherein the one or more computer programs further include computer-executable instructions that, when executed by the one or more processors individually or collectively, cause the electronic device to change the number of frames per second of the application related to the system user interface from the first value to a fourth value after a specified time elapses from a time of changing the number of frames per second of the watchface to the third value and before the first screen is removed.

6. The electronic device of claim 1, wherein the one or more computer programs further include computer-executable instructions that, when executed by the one or more processors individually or collectively, cause the electronic device to control a first application module included in a software module stored in the memory to process a process for displaying the first screen, performing the initialization, and executing the application.

7. The electronic device of claim 6,
wherein the one or more computer programs further include computer-executable instructions that, when executed by the one or more processors individually or collectively, cause the electronic device to control a second application module included in the software module to process a process for displaying the second screen, and
wherein the second application module processes a process related to execution of the watchface and includes at least one module related to the watchface.

8. A method performed by an electronic device, the method comprising:
executing, by the electronic device, an application related to a system user interface (UI) in a locked state;
displaying, by the electronic device, a first screen indicating initialization through the application;
generating, by the electronic device, an image related to a watchface while performing the initialization and displaying the first screen and a second screen including the image on a display of the electronic device;
switching, by the electronic device, the locked state to an unlocked state while performing the initialization; and
based on completion of the initialization, removing, by the electronic device, the first screen and displaying the second screen on the display.

9. The method of claim 8, further comprising changing each of a number of frames per second of the application and a number of frames per second of the watchface while performing the initialization.

10. The method of claim 9,
wherein the changing of each of the number of frames per second of the application and the number of frames per second of the watchface while performing the initialization includes:
setting each of a number of frames per second of the application and a number of frames per second of the watchface to a first value after starting the initialization; and
displaying, on the display, each of the first screen and the second screen at the number of frames per second of the first value during a first time period after starting the initialization, and
wherein the image included in the second screen includes objects indicating information related to execution of modules related to the watchface.

11. The method of claim 10, wherein the changing of each of the number of frames per second of the application and the number of frames per second of the watchface while performing the initialization includes:
based on the switching to the unlocked state and completion of initial execution of at least one module related to the watchface, changing the number of frames per second of the watchface from the first value to a second value; and
displaying the second screen at the number of frames per second of the second value and the first screen at the number of frames per second of the first value during a second time period after the completion of the initial execution of the at least one module related to the watchface.

12. The method of claim 11,
wherein the changing of each of the number of frames per second of the application and the number of frames per second of the watchface while performing the initialization includes:
changing the number of frames per second of the watchface to a third value after a specified time elapses after the change to the second value, and before completion of the initialization; and
displaying the second screen at the number of frames per second of the third value from a time of the change to the third value,
wherein the first value is a value less than the second value, and
wherein the third value is a value greater than the second value.

13. The method of claim 12, wherein the changing of each of the number of frames per second of the application and the number of frames per second of the watchface while performing the initialization includes changing the number of frames per second of the application from the first value to a fourth value after a specified time elapses from a time of changing the number of frames per second of the watchface to the third value and before the first screen is removed.

14. One or more non-transitory storage media storing one or more computer programs including computer-executable instructions that, when executed by one or more processors of an electronic device individually or collectively, cause the electronic device to perform operations, the operations include:
executing, by the electronic device, an application related to a system user interface (UI) in a locked state;
displaying, by the electronic device, a first screen indicating initialization through the application;
generating, by the electronic device, an image related to a watchface while performing the initialization and displaying the first screen and a second screen including the image on a display of the electronic device;
switching, by the electronic device, the locked state to an unlocked state while performing the initialization; and
based on completion of the initialization, removing, by the electronic device, the first screen and display the second screen on the display.

15. The one or more non-transitory computer-readable storage media of claim 14, the operations further comprising changing each of a number of frames per second of the application and a number of frames per second of the watchface while performing the initialization.

16. The one or more non-transitory computer-readable storage media of claim 15,
wherein the changing of each of the number of frames per second of the application and the number of frames per second of the watchface while performing the initialization includes:
setting each of a number of frames per second of the application and a number of frames per second of the watchface to a first value after starting the initialization; and
displaying, on the display, each of the first screen and the second screen at the number of frames per second of the first value during a first time period after starting the initialization, and
wherein the image included in the second screen includes objects indicating information related to execution of modules related to the watchface.

17. The one or more non-transitory computer-readable storage media of claim 16, wherein the changing of each of the number of frames per second of the application and the number of frames per second of the watchface while performing the initialization includes:
based on the switching to the unlocked state and completion of initial execution of at least one module related to the watchface, changing the number of frames per second of the watchface from the first value to a second value; and
displaying the second screen at the number of frames per second of the second value and the first screen at the number of frames per second of the first value during a second time period after the completion of the initial execution of the at least one module related to the watchface.

18. The one or more non-transitory computer-readable storage media of claim 17,
wherein the changing of each of the number of frames per second of the application and the number of frames per second of the watchface while performing the initialization includes:
changing the number of frames per second of the watchface to a third value after a specified time elapses after the change to the second value, and before completion of the initialization; and
displaying the second screen at the number of frames per second of the third value from a time of the change to the third value, wherein the first value is a value less than the second value, and wherein the third value is a value greater than the second value.

19. The one or more non-transitory computer-readable storage media of claim 18, wherein the changing of each of the number of frames per second of the application and the number of frames per second of the watchface while performing the initialization includes changing the number of frames per second of the application from the first value to a fourth value after a specified time elapses from a time of changing the number of frames per second of the watchface to the third value and before the first screen is removed.
